(19) United States
(12) Patent Application Publication
(10) Pub. No.: US 2011/0056441 A1
(43) Pub. Date: Mar. 10, 2011

(54) STRUCTURE OF PET BAG

(76) Inventor: YU LIEN CHANG, Panchiao City (TW)

(21) Appl. No.: 12/554,997

(22) Filed: Sep. 8, 2009

(51) Int. Cl. A01K 31/07

(52) U.S. Cl. 119/453

(57) ABSTRACT

A pet bag includes an upper bag portion and a lower bag portion, which are connectable to or separable from each other. The upper bag portion has two opposite side surfaces to which openable side panels are attached and front and rear surfaces which form openings to which scrollable screens and cover panels are attached. The lower bag portion has a bottom to which casters are mounted and opposite side surfaces to which an extendable towing bar assembly is attached. A mat is set inside the lower bag portion. As such, the pet bag may receive and hold a pet therein and the pet bag can be hand or shoulder carried or trolleyed. The upper and lower bag portions can be separated to individually serve as a pet house. When not in use, the upper bag portion can be collapsed and stored in the lower bag portion.

### TECHNICAL FIELD OF THE INVENTION

The present invention generally relates to a pet bag, and more particularly to the structure of a pet bag that allows for hand or shoulder carrying or trolleying and also allows upper and lower portions thereof to be separated to serve as pet houses and also allows for collapse to facilitate storage and carrying.

### DESCRIPTION OF THE PRIOR ART

A conventional pet bag or pet cage for carrying a pet outdoors is often constructed as a fixed bag or cage and is only of a function for hand or shoulder carrying without extra functions. When the pet bag or cage is not in use, the pet bag or cage as a whole occupies quite an amount of space and serves no other purposes. This is of course not an idea design. Further, the conventional pet bag is of a fixed design and is not allowed to collapse for easy storage when it is not in use. This causes troubles in storage and carrying. In view of these problems, the present invention aims to provide a pet bag that makes the use and storage of the pet bag versatile and convenient.

### SUMMARY OF THE INVENTION

The primary purpose of the present invention is to provide a pet bag that allows for hand or shoulder carrying or trolleying when used outdoors and also allows upper and lower portions thereof to be separated to serve as pet houses and also allows for collapse to facilitate storage and carrying when not in use.

In accordance with the present invention, a pet bag is provided, comprising an upper bag portion and a lower bag portion, which are connectable to or separable from each other. The upper bag portion has two opposite side surfaces to which openable side panels are attached and front and rear surfaces which form openings to which scrollable screens and cover panels are attached. The lower bag portion has a bottom to which casters are mounted and opposite side surfaces to which an extendable towing bar assembly is attached. A mat is set inside the lower bag portion. As such, a pet bag is formed. The pet bag may receive and hold a pet therein and the pet bag can be hand or shoulder carried or trolleyed. The upper and lower bag portions can be separated to individually serve as a pet house. When not in use, the upper bag portion can be collapsed and stored in the lower bag portion to facilitate storage and carrying, whereby the user of the pet bag is made versatile and convenient.

In the pet bag in accordance with the present invention, zipper portions are respectively arranged along joint sections of the upper and lower bag portions whereby the upper and lower bag portions can be connected to or separated from each other through engagement or disengagement of the zipper portions.

In the pet bag in accordance with the present invention, the upper bag portion has an inside surface having opposite sides to which elongate tubular receiving sleeves are mounted to receive support bars to fit therein to expand the upper bag portion.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a pet bag in accordance with the present invention.

FIG. 2 is an exploded view of the pet bag of the present invention.

FIG. 3 is a perspective view of an upper gap portion of the pet bag of the present invention in an upper-side down manner illustrating the arrangement of support bars of the upper bag portion.

FIG. 4 is a perspective view showing a first example of use of the pet bag in accordance with the present invention.

FIG. 5 is a perspective view showing a second example of use of the pet bag in accordance with the present invention.

FIG. 6 is a perspective view showing a third example of use of the pet bag in accordance with the present invention.

FIG. 7 is a perspective view showing a fourth example of use of the pet bag in accordance with the present invention.

FIG. 8 is a perspective view showing the collapse of the pet bag of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

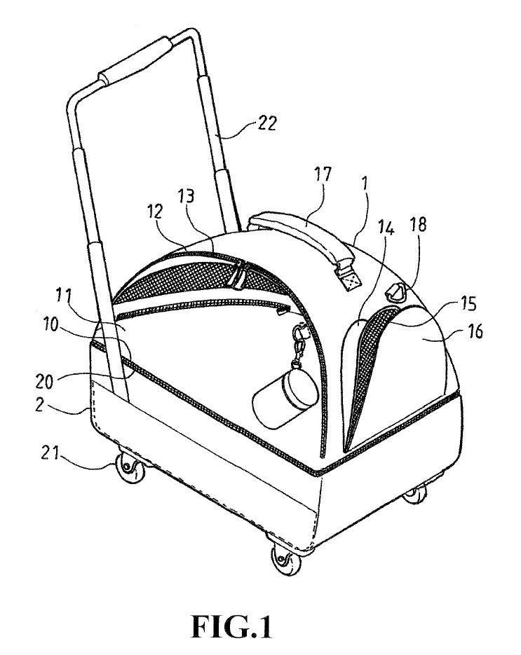

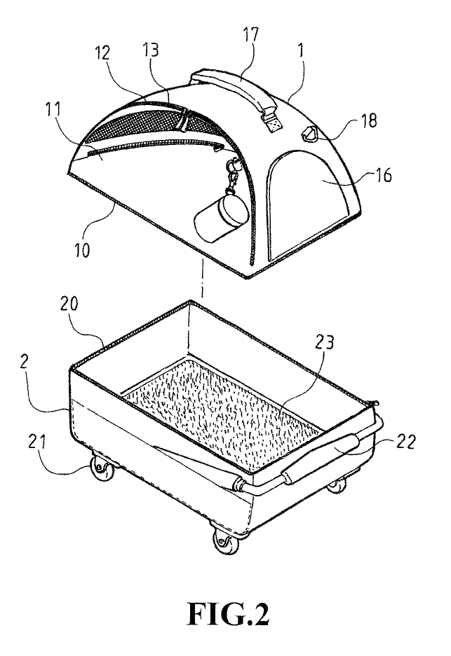

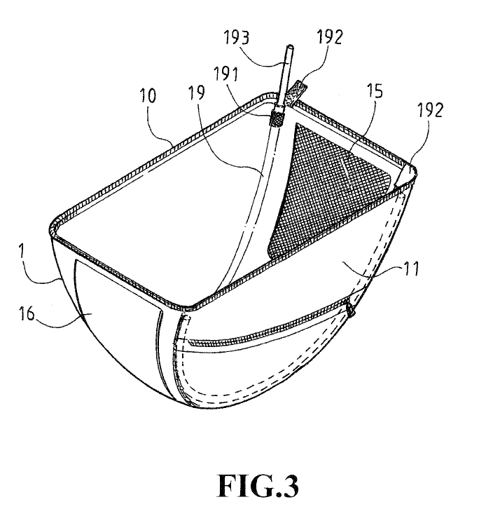

Referring to FIGS. 1 and 2, which are respectively a perspective view and an exploded view of a pet bag constructed in accordance with the present invention, and also referring to FIG. 3, which is a perspective view of an upper gap portion of the pet bag in an upper-side down manner illustrating the arrangement of support bars of the upper bag portion, the pet bag according to the present invention comprises an upper bag portion 1 and a lower bag portion 2, which are connectable to or separable from each other. The upper bag portion 1 forms a first zipper portion 10 along a joint section thereof with the lower bag portion 2, and also comprises an openable flexible side panel 11 on each of two opposite side surfaces thereof. Zippers 12, 13 are arranged to respectively connect between the two side panels 11 and the upper bag portion 1. Through engagement or disengagement of the zippers 12, 13, the side panels 11 can be closed to the upper bag portion 1 or opened from the upper bag portion 1. The upper bag portion 1 has front and rear surfaces, each forming an opening 14 to which a scrollable screen 15 and a cover panel 16 for shielding the screen 15 are attached.

The upper bag portion 1 has a top surface to which a hand carrying handle 17 is mounted at a central portion of the top surface. Two hanging buckles 18 are respectively mounted to opposite side portions of the top surface for connecting a shoulder carrying strap. Two elongate tubular receiving sleeves 19 are mounted to an inside surface of the upper bag portion 1 and on opposite sides. Each receiving sleeve 19 is provided with male and female fastening members 191, 192, such as hook members and loop members of hook-and-loop fasteners, at ends and side surfaces thereof, whereby support bars 193 are receivable in the receiving sleeves 19 to expand the upper bag portion and the support bars 193 are fixed in position by the inter-engagement between the male and female fastening members 191, 192.

The lower bag portion 2 forms a second zipper portion 20 along a joint section thereof with the upper bag portion 1 and has a bottom to which casters 21 are mounted. Extendible towing bar assembly 22 is attached to opposite side surfaces of the lower bag portion 2. A mat 23 is set inside and on the bottom of the lower bag portion 2.

The previously discussed components, when assembled together, provide a pet bag. The pet bag may receive and hold a pet therein. When moving outdoors, a pet owner may carry the pet bag by hand carrying the handle 17, or by shoulder carrying a shoulder strap attached to the two buckles 18, or by using the towing bar assembly to tow or push the pet bag. When the pet bag is positioned in an indoor environment, the upper and lower bag portions 1, 2 can be separated from each other, whereby both the upper and lower bag portions 1, 2 may serve as a hide-out or a house for pets. When the pet bag is not in use, the upper bag portion 1 can be collapsed and stored inside the lower bag portion 2 to facilitate carrying or storage. Thus, the use of the pet bag is made versatile and convenient.

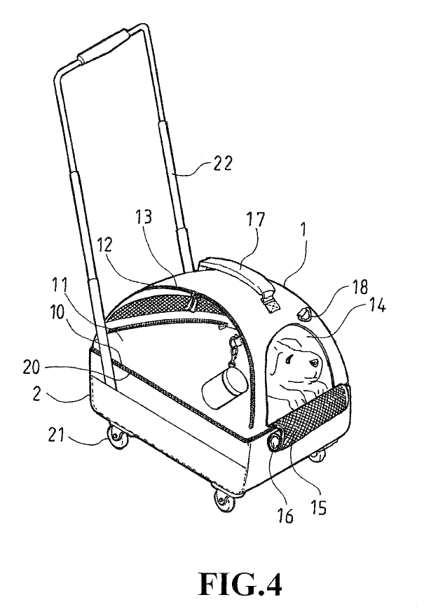

Referring to FIG. 4, a first example of use of the present invention is shown. The upper and lower bag portions 1, 2 are coupled to each other through engagement of the zipper portions 10, 20 to each other and a pet is put inside the pet bag. The screen 15 and the cover panel 16 are attached to and close the opening 14, or alternatively, the screen 15 and the cover panel 16 are wound to allow the pet to be exposed through the opening 14. The towing bar assembly 22 is set slightly inclined rearward and the towing bar assembly 22 is stretched upward to a desired length, whereby a user or pet owner may push or tow the towing bar assembly 22 to move the pet bag through the rotation of the casters 21, making carrying the pet outdoor more effort saved and convenient. The user or pet owner may observe the pet from the upper side.

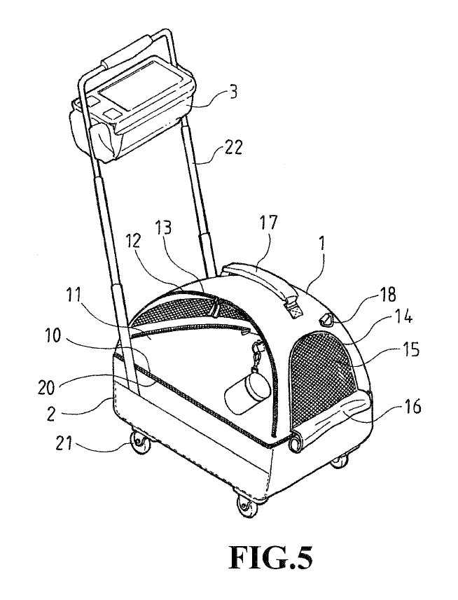

Referring to FIG. 5, a second example of use of the present invention is shown. As shown, besides the pet owner pushing the pet bag forward through the towing bar assembly 22 for carrying a pet in an effort saved manner, the pet owner may also make observation of the pet from the upper side. If desired, a container 3 may be set between and attached to side bars of the towing bar assembly 22 for receiving and carrying pet articles, feeds, or personal articles of the pet owner, whereby the pet bag also provides a function of carrying articles.

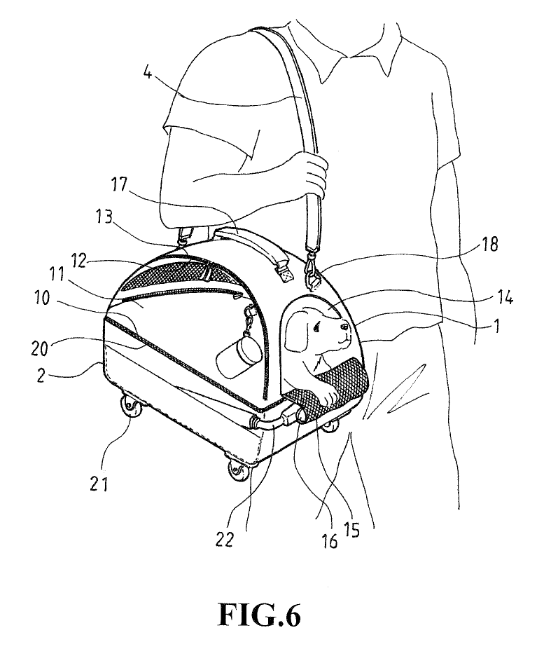

Referring to FIG. 6, a third example of use of the present invention is shown, which demonstrates another way of carrying the pet bag of the present invention. A shoulder carrying strap 4 has opposite ends attached to the buckles 18 mounted to opposite sides of the upper bag portion 1. The screen 15 and the cover panel 16 are attached to and close the opening 14, or alternatively, the screen 15 and the cover panel 16 are wound to allow the pet to be exposed through the opening 14. In this way, the pet bag can be moved with the pet owner.

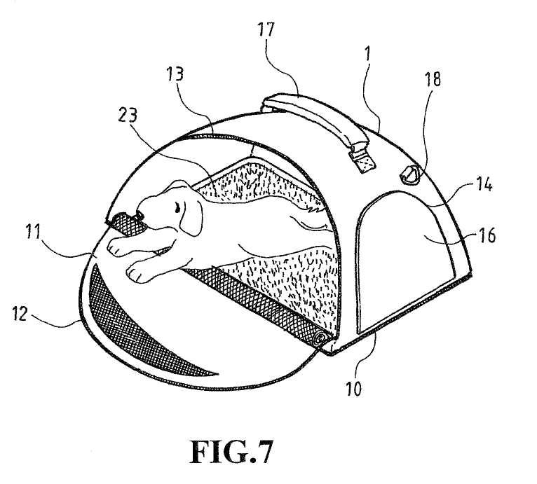

Referring to FIG. 7, a fourth example of use of the present invention is shown. As shown, when the pet bag of the present invention is positioned in an indoor environment, through disengagement of the zipper portions 10, 20 from each other, the upper bag portion 1 and the lower bag portion 2 are separated from each other. The side panels 11 of the upper bag portion 1 are released by unzipping the zippers 12, 13 (see FIG. 2) so that the side panels 11 are opened from the upper bag portion 1. The mat 23 that is originally set inside the lower bag portion 2 is removed from the lower bag portion 2 and re-positioned inside the upper bag portion 1 to thereby allow the upper bag portion 1 to serve as a pet house. The lower bag portion 2 may also be directly used as a pet house.

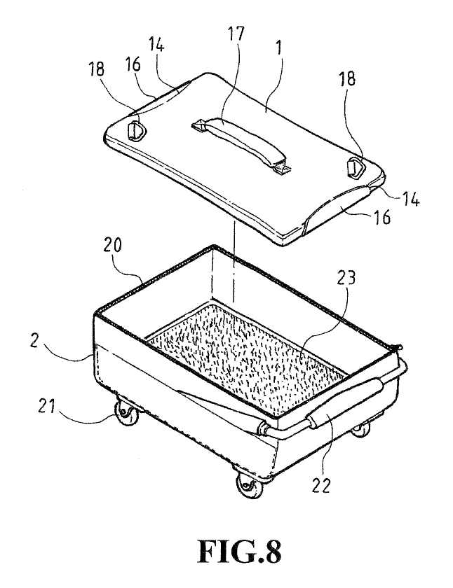

Referring to FIG. 8, collapse of the present invention is demonstrated. As shown, when the pet bag is not in use, the male and female fastening members 191, 192 (see FIG. 3) that are mounted to the receiving sleeves 19 of the upper bag portion 1 are detached from each other to allow the support bars 193 to be removed out of the receiving sleeves 19. After removal of the support bars 193 from the receiving sleeves 19, the upper bag portion 1 is not longer supported in an expanded condition so that the upper bag portion 1 can be collapsed to be received and stored inside the lower bag portion 2 to reduce the overall size. Thus, the storage of the pet bag does not occupy a great amount of space and transportation and carrying are made easy.

Alternative use can be found for the bag of the present invention. For example, when the pet bag is not used to hold a pet, with the upper and lower bag portions 1, 2 coupled to each other and the side panels 11 and the cover panels 16 closed, the bag of the present invention may serve as a luggage bag or a shopping bag.

It is noted that the present invention provide a pet bag that comprises upper and lower bag portions to which a towing bar assembly and hanging buckles are attached so as to allow the pet bag to be trolleyed or shoulder carried or hand carried, and the upper and lower bag portions can be separated from each other to serve as individual pet houses. When not in use, the pet bag can be collapsed to facilitate storage and carrying.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A pet bag, comprising:
an upper bag portion, which has two opposite side surfaces to which openable side panels are attached and front and rear surfaces which form openings to which scrollable screens and cover panels are attached, the upper bag portion having an inside surface having opposite sides to which two elongate tubular receiving sleeves are respectively mounted for receiving support bars to fit therein to expand the upper bag portion; and
a lower bag portion, which has a bottom to which casters are mounted, an extendable towing bar assembly being attached to opposite side surfaces of the lower bag portion, a mat being set inside the lower bag portion;
wherein the pet bag is formed by assembling the portions together whereby the pet bag selectively receives and holds a pet therein and is adapted to be carried by a hand or a shoulder of a pet owner when the pet bag is carried outdoors or the peg bag is trolleyed through hand operating the towing bar assembly, and whereby when the pet bag is positioned in an indoor environment, the upper and lower bag portions are selectively separated from each other to allow both the upper and lower bag portions to serve as houses for pets, and whereby when the pet bag is not in use, the upper bag portion is collapsed and stored inside the lower bag portion to facilitate carrying or storage, thereby making the use of the pet bag versatile and convenient.

2. The pet bag according to claim 1, wherein the side panels of the upper bag portion each comprise a zipper connecting between each of the side panel and the upper bag portion, whereby through engagement or disengagement of the zipper, the side panel is closed to the upper bag portion or opened from the upper bag portion.

3. The pet bag according to claim 1, wherein the upper bag portion has a top surface to which a handle is mounted at a central portion of the top surface for hand carrying the pet bag.

4. The pet bag according to claim 1, wherein buckles are set at opposite side portions of a top surface of the upper bag portion to selectively connect to a strap to allow the pet bag to be shoulder carried.

5. The pet bag according to claim 1, wherein each of the receiving sleeves mounted to the inside surface of the upper bag portion is provided with male and female fastening members at ends and side surfaces thereof, whereby the support bars received in the receiving sleeves are fixed in position by the inter-engagement between the male and female fastening members.
